(19) United States
(12) Patent Application Publication
(10) Pub. No.: US 2009/0171725 A1
(43) Pub. Date: Jul. 2, 2009

(54) PROCESS AND APPARATUS FOR SELLER CREDIBILITY VERIFICATION IN TRADING OF FACTUAL OR OPINIONATIVE INFORMATION

(76) Inventor: Dmitri Okhotski, (US)

Correspondence Address: Dmitri Okhotski, 2973 Harbor Blvd #475, Costa Mesa, CA, 92626, US

(21) Appl. No.: 12/351,848

(22) Filed: Jan. 11, 2009

(51) Int. Cl. G06Q 10/00; G06Q 30/00

(52) U.S. Cl. 705/7

(57) ABSTRACT

A process and an apparatus that perform seller credibility verification in trading of factual or opinionative information are disclosed. When buying information, buyers already have some prior information about the subject of the purchase. The present invention facilitates comparison of said prior information known by buyers with information known by sellers without revealing the content of the sellers' information to buyers before the sale completion. A buyer submits to a network server for the selected seller a verification request comprising the data the buyer expects the seller to know. The network server interacts with the seller and other data sources to obtain seller's verification data representing the seller's knowledge. The network server uses the seller's verification data for comparison against the data expected by the buyer. The comparison report not revealing the content of the seller's verification data is provided to the buyer.

### RELATED APPLICATIONS

The present application is related to U.S. Pat. No. 7,454,004, issued Nov. 18, 2008, included by reference herein.

The present application is related to U.S. Pat. No. 7,219,232, issued May 15, 2007, included by reference herein.

The present application is related to U.S. Pat. No. 6,834,272, issued Dec. 21, 2004, included by reference herein.

The present application is related to United States patent application number 20040049517, filed on Sep. 3, 2002, included by reference herein.

### FIELD OF THE INVENTION

The present invention relates to seller credibility verification in trading of factual or opinionative information, more particularly, to network server functionality performing seller credibility verification for minimizing the disclosure of selling information by sellers to buyers prior to sale completion in trading of factual or opinionative information.

### BACKGROUND OF THE INVENTION

Information takes many forms like news, blogs, recommendations, electronic books, research papers, scientific and non scientific articles, audio recordings, video recordings, photographs, images, maps, personal data, credit history, financial records, health records, criminal records, driving records, statistical data, analytical results, databases, knowledgebases, and other forms known to those skilled in the art. Factual information describes facts about someone, something, or about an event that is occurring now, happened in the past, or scheduled to happen in the future. Opinionative information is someone's view on facts or events. In other words, it is a subjective interpretation of factual information. Information usually travels from a source of information to a consumer of information. Information trading systems serve as intermediaries that allow holders of information to become sellers and consumers of information to become buyers within the networked environment.

A typical trade of information involves payment of money for transfer of information. There are at least two sides in information trade transactions: buyers and sellers. Buyers prefer not to pay money until they get sufficient guarantees that the purchasing information is worth their money. Buyers usually either trust sellers or demand disclosure of some part of the purchasing information to get an idea about its content before purchasing. How much information a particular buyer wants a particular seller to disclose depends mostly on the reputation of the seller. Sellers prefer not to disclose any part of the selling information for free, because that would reduce the amount of information left for sale and would give buyers an opportunity to walk away with the received for free information. However currently, sellers without well established reputation are having a hard time selling their information without some kind of disclosure. Sellers are more protected than buyers during such information sale transactions, because modern online services of regular banks ensure reliable transfers of money for sellers, but buyers have little or no guarantees regarding the content and the value of purchasing information. Moreover, the value of information is very subjective and can be determined with certainty only after reviewing the content of the information. So, buyers have valid reasons to demand disclosure of some of the purchasing information prior to buying. Clearly, buyers and sellers have opposite interests regarding disclosure of the selling information. And the reputation of sellers is one of the important decision making factors for buyers.

At the present time, companies and individuals that sell information on the Internet use primarily two main techniques to pitch their information to potential buyers. The first technique is obfuscation, where sellers distort the selling information so to disclose to potential buyers only its general layout or a vague description. Said technique is used by financial analysts that present their work on the Internet in minimized form so the letters, numbers, and charts are not readable. With this technique, buyers have very few guarantees of quality of the purchasing information; buyers rely heavily on sellers' reputations derived from various sources and from their own past experiences; buyers also rely on their own imagination of what the content of the purchasing information might be. The second technique is a partial disclosure of selling information, where sellers reveal some part of the selling information to potential buyers for free. It is widely used by online book sellers where said sellers display on the Internet the table of contents and the first several pages of selling books for free. Said technique works well on large volumes of information where revealing a part of the information does not diminish much the value of the rest of the information. However, it performs poorly on small volumes of very concise data. It encourages buyers to walk away with the received information without paying the money.

None of the above techniques offers sufficient guarantees to buyers and sellers that trade information infrequently, trade small volumes of data, and don't have well established reputation online. It would be advantageous to have a system that addresses the drawbacks of the above techniques by allowing buyers to verify sellers' capability to provide quality information sought by buyers, while at the same time, helping sellers to minimize the disclosure of the selling information prior to sale completion.

### SUMMARY OF THE INVENTION

The present invention relates to seller credibility verification in trading of factual or opinionative information and allows minimizing the disclosure of selling information by sellers to buyers prior to sale completion. In response to credibility verification request from a buyer, the present invention performs a series of steps leading to generation of the report describing credibility of the selected seller in regard to information the seller sells. In one embodiment, the present invention performs a series of steps to provide a buyer with the report based on data obtained either with or without interaction with a seller. In another embodiment, the present invention performs actions to provide a buyer with the report based on data obtained from interaction with a seller.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an illustration of typical parties participating in trading of factual or opinionative information;

FIG. 2 is a combined block-sequence diagram of the preferred embodiment of seller credibility verification process;

FIG. 3 is a combined block-sequence diagram of another embodiment of seller credibility verification process; and

FIG. 4 is an exemplary content of credibility verification request.

For purposes of clarity and brevity, like elements and components will bear the same designations and numbering throughout the Figures.

### DETAILED DESCRIPTION OF THE INVENTION

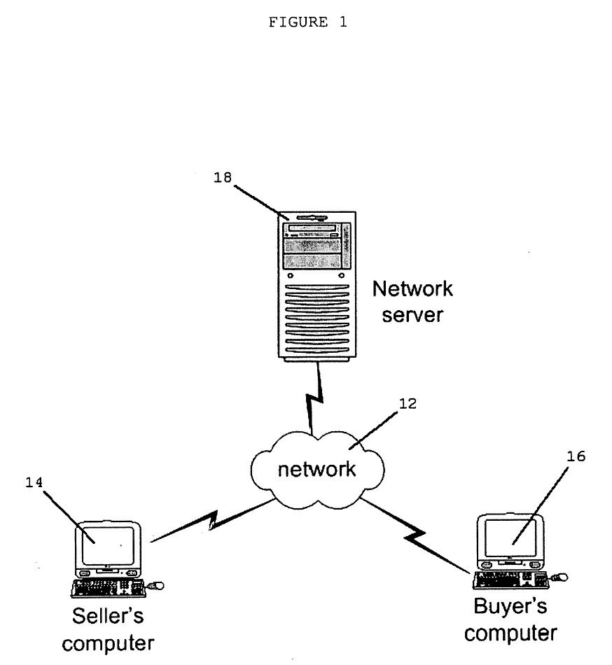

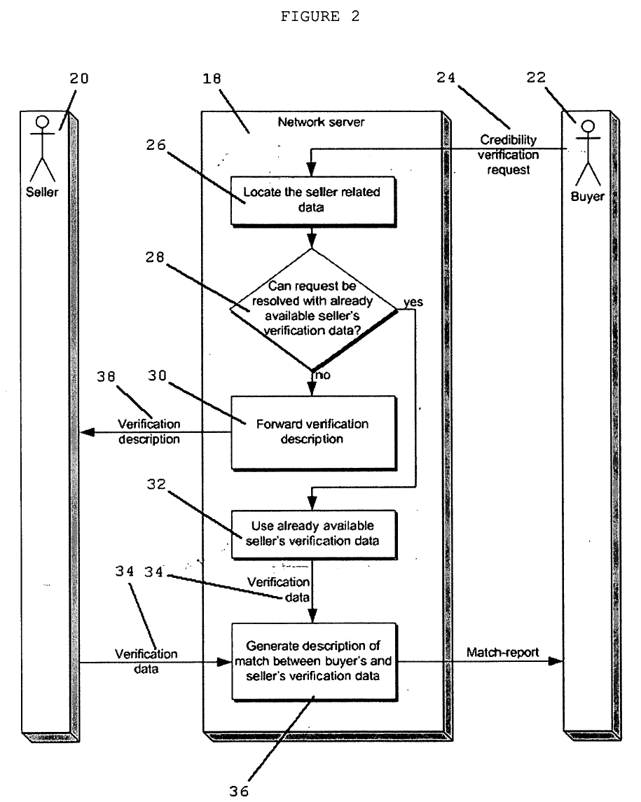

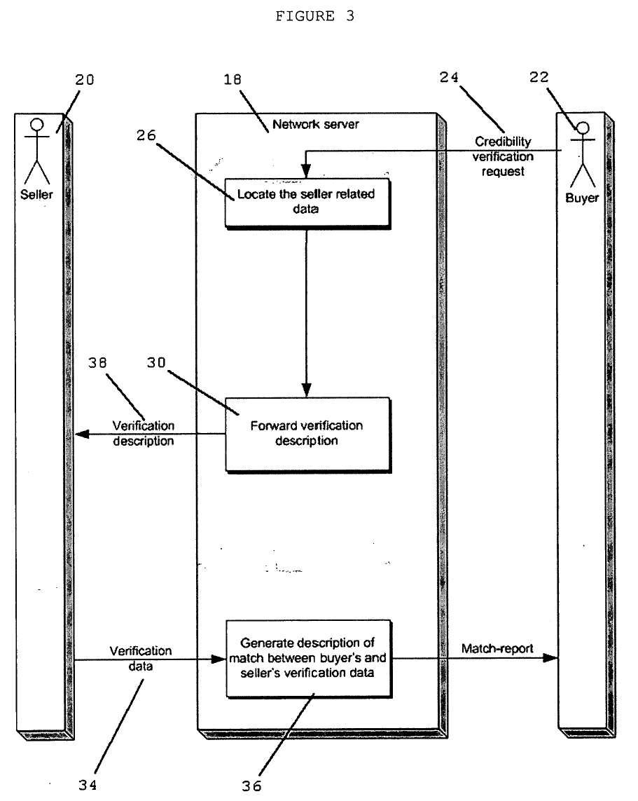

FIG. 1 is an illustration of typical parties participating in trading of factual or opinionative information. The present invention is embodied in a network server 18 performing a seller credibility verification process. The network server 18 is accessible via a network 12 connection. Communication links within the network 12 may be twisted wire, coaxial cable, fiber-optic, wireless links, telephone lines, digital lines, or other communication links known to those skilled in the art. The network 12 may be a single or a plurality of networks. Also, the network 12 may be an internetwork such as the Internet. A buyer's computer 16, a seller's computer 14, and the network server 18 may each be a single or a plurality of personal digital assistants, phones, cell phones, smart phones, personal computers, shared computers, servers, gaming consoles, television sets, set-top-boxes, or other devices able to communicate via the network 12. The buyer's computer 16, the seller's computer 14, and the network server 18 may each be connected to the network 12 using any method or device known to those skilled in the art. The buyer's computer 16 (FIG. 1) is equipment used by a buyer 22 (FIG. 2, FIG. 3). The seller's computer 14 (FIG. 1) is equipment used by a seller 20 (FIG. 2, FIG. 3).

The network server 18 may be providing communication through a single or a plurality of communication protocols. Said communication protocols could be a hypertext transfer protocol (“HTTP”), secure hypertext transfer protocol (“HTTPS”), file transfer protocol (“FTP”), post office protocol (“POP”), internet message access protocol (“IMAP”), simple mail transfer protocol (“SMTP”), transmission control protocol (“TCP”), user datagram protocol (“UDP”), internet protocol (“IP”), voice over IP protocol (“VOIP”), human or machine generated speech, tone or pulse encoded sequences like those used in modern phones, various audio communication protocols, various video communication protocols, or any other communication protocols known to those skilled in the art. The buyer's computer 16 and the seller's computer 14 may each be using communication software that utilizes communication protocols supported by the network server 18. Said communication software may be a web browser, an e-mail client, an instant messenger, audio or video transmission software, embedded communication software which is sometimes called firmware, or any other communication software known to those skilled in the art.

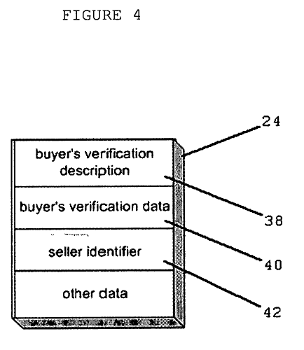

FIG. 2 and FIG. 3 are the combined block-sequence diagrams of the two separate embodiments of the seller credibility verification process. FIG. 4 is an exemplary content of the credibility verification request. To initiate the process of seller credibility verification on the network server 18, the buyer 22 submits to the network server 18 the credibility verification request 24 comprising the buyer's verification description 38, the buyer's verification data 40, and the seller identifier 42. Said submission of said request could be either a one step transfer of data by the buyer 22 to the network server 18 or an interactive multi-step communication between the buyer 22 and the network server 18. The buyer's verification description 38 may be viewable by the seller 20; it is the data either describing or referencing the description of what the buyer 22 is expecting the seller 20 to verify. The buyer's verification data 40 is not visible to the seller 20 during said credibility verification process. The buyer's verification data 40 is approximate data that the buyer 22 expects the seller 20 to provide to the network server 18 as a proof of credibility. A reference on the buyer's verification data 40 could be used in place of the buyer's verification data 40. The seller identifier 42 could be any data that is directly or indirectly identifies the seller 20 on the network server 18. The network server 18 may use the seller identifier 42 when it locates the seller related data 26. Whenever a reference on data is passed to the network server 18 in place of actual data, the network server 18 obtains the actual data for the steps of the process that require that actual data.

In the preferred embodiment, as depicted on FIG. 2, the network server 18 receives the credibility verification request 24, locates the seller related data 26, and then makes the decision 28 either to resolve said request by using already available seller's verification data 32 or to proceed with forwarding the buyer's verification description 30 to the seller 20. Already available data is a data that without interaction with the seller 20 can be obtained by the network server 18 from any data sources known to those skilled in the art. Also, said already available data could have previously been accumulated by the network server 18 by preserving the seller's verification data 34 submitted earlier by the seller 20. When the network server 18 makes the decision 28, it may search said already available data for seller's verification data 34 potentially suitable for the buyer's verification description 38 (FIG. 4) from the buyer's credibility verification request 24. Also, when the network server 18 makes the decision 28, the network server 18 may consider availability of the seller's verification data 34, accessibility of the seller's verification data 34, or any other factors related to the seller's verification data 34, related to the buyer's verification description 38 (FIG. 4), related to the seller 20, related to the buyer 22, or related to the network server 18. There are at least two possible outcomes of said decision. The first outcome is the network server 18 uses already available seller's verification data 32 on the subsequent steps of the process. The second outcome is the network server 18 contacts the seller 20 by forwarding the buyer's verification description 30 to the seller 20, then after receiving the response from the seller 20, the network server 18 uses in subsequent steps of the process the seller's verification data 34 received inside said response. A reference on said seller's verification data 34 could be used in place of seller's verification data 34. In such case, the network server 18 would obtain the seller's verification data 34 using said reference. After the network server 18 makes the decision 28, said outcomes provide the seller's verification data 34 for the subsequent steps of the process. No matter how the seller's verification data 34 was obtained, the network server 18 generates the match report 36 by comparing the seller's verification data 34 with the buyer's verification data 40 (FIG. 4) from the buyer's credibility verification request 24. Using the results of said comparison, the network server 18 composes the match report comprising descriptive data, wherein said report does not reveal the content of the used during comparison seller's verification data 34. When the network server 18 generates the match report 36, the network server 18 may use algorithms of statistical, probabilistic, graphical, geometrical, audio, or other types of analysis known to those skilled in the art. Said match report is then provided to the buyer 22.

This embodiment may further be extended by adding a security feature that limits a number of match reports provided to a buyer 22, wherein said match reports are prepared using the same seller's verification data 34. Said feature may prevent buyers from figuring out the seller's verification data 34 when the seller's verification data 34 have limited number of possible variations. Limitations on possible variations of seller's verification data 34 may be imposed by buyers in the buyer's verification description 38 of the credibility verification request 24.

In another embodiment, as depicted on FIG. 3, after receiving the credibility verification request 24 from the buyer 22, the network server 18 locates the seller related data 26, and then contacts the seller 20 by forwarding the buyer's verification description 30 to the seller 20. After the seller 20 responds by submitting either seller's verification data 34 or a reference on said data to the network server 18, the network server 18 generates the match report 36 by comparing the seller's verification data 34 from the seller's response against the buyer's verification data 40 (FIG. 4) from the buyer's credibility verification request 24. Using the results of said comparison, the network server 18 composes the match report comprising descriptive data, wherein said report does not reveal the content of the used during comparison seller's verification data 34. When the network server 18 generates the match report 36, the network server 18 may use algorithms of statistical, probabilistic, graphical, geometrical, audio, or other types of analysis known to those skilled in the art. Said match report is then provided to the buyer 22.

By providing to buyers match reports prepared in accordance with the present invention, the present invention minimizes the disclosure of selling information by sellers to buyers, while at the same time, gives buyers something describing the credibility of sellers.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A process and apparatus for seller credibility verification in trading of factual or opinionative information for minimizing the disclosure of selling information by sellers to buyers prior to sale completion, comprising:
means for providing communication with buyers and sellers;
means for receiving a credibility verification request from a buyer;
means for forwarding a buyer's verification description to a seller;
means for receiving seller's verification data from a seller; and
means for generating a report of match between buyer's verification data and seller's verification data, wherein said report does not reveal the content of the seller's verification data.

2. The process and apparatus of claim 1, wherein said means for providing communication with buyers and sellers comprise a network server.

3. The process and apparatus of claim 1, wherein said means for receiving a credibility verification request from a buyer comprise a network server.

4. The process and apparatus of claim 1, wherein said means for forwarding a buyer's verification description to a seller comprise a network server.

5. The process and apparatus of claim 1, wherein said means for receiving seller's verification data from a seller comprise a network server.

6. The process and apparatus of claim 1, wherein said means for generating a report of match between buyer's verification data and seller's verification data comprise a network server.

7. The process and apparatus of claim 1, further comprising a network server making the decision either to use already available seller's verification data or to contact a seller.

8. The process and apparatus of claim 7, further comprising a network server using already available seller's verification data for generation of the report of match between buyer's verification data and seller's verification data, wherein said report does not reveal the content of the seller's verification data.

9. A process and apparatus for seller credibility verification in trading of factual or opinionative information for minimizing the disclosure of selling information by sellers to buyers prior to sale completion, comprising:
means for providing communication with buyers and sellers;
means for receiving seller's verification data and preserving it for later access, wherein said access does not involve interaction with the seller;
means for receiving a credibility verification request from a buyer;
means for locating available seller's verification data, wherein said data can be accessed without interaction with the seller;
means for generating a report of match between buyer's verification data and seller's verification data, wherein said report does not reveal the content of the seller's verification data; and
means for limiting a number of match reports provided to a buyer, wherein said reports are generated using the same seller's verification data;

10. The process and apparatus of claim 9, wherein said means for providing communication with buyers and sellers comprise a network server.

11. The process and apparatus of claim 9, wherein said means for receiving seller's verification data and preserving it for later access comprise a network server.

12. The process and apparatus of claim 9, wherein said means for receiving a credibility verification request from a buyer comprise a network server.

13. The process and apparatus of claim 9, wherein said means for locating available seller's verification data comprise a network server.

14. The process and apparatus of claim 9, wherein said means for generating a report of match between buyer's verification data and seller's verification data comprise a network server.

15. The process and apparatus of claim 9, wherein said means for limiting a number of match reports provided to a buyer comprise a network server.
